(19) United States
(12) Patent Application Publication
(10) Pub. No.: US 2026/0178561 A1
(43) Pub. Date: Jun. 25, 2026

(54) FILE UPDATE FREQUENCY INDICATIONS FOR MEMORY OPERATIONS

(71) Applicant: Micron Technology, Inc., Boise, ID (US)

(72) Inventors: Chaohui Liu, Shanghai (CN); Liang Ge, Shanghai (CN); Ming Ma, Shanghai (CN)

(21) Appl. No.: 19/422,200

(22) Filed: Dec. 16, 2025

Related U.S. Application Data
(60) Provisional application No. 63/737,169, filed on Dec. 20, 2024.

(51) Int. Cl. G06F 16/23

(52) U.S. Cl. CPC G06F 16/2358

(57) ABSTRACT

Methods, systems, and devices for file update frequency indications for memory operations are described. A host system may indicate an update frequency of a file, such that a memory system may write the file to a first region of memory or a second region of memory according to the update frequency. For example, the host system may determine an update to a file and transmit commands to modify data of the file. The host system may also transmit an update frequency associated with the file, where the update frequency may be a function of a quantity of modified logical block addresses (LBAs) associated with the file, a bootup duration, a modification time of updating the file, or any combination thereof. The memory system may modify the data and write the modified data to the hot region of memory or cold region of memory according to the update frequency.

### CROSS REFERENCE

The present application for patent claims priority to U.S. Patent Application No. 63/737,169 by Liu et al., entitled “FILE UPDATE FREQUENCY INDICATIONS FOR MEMORY OPERATIONS,” filed Dec. 20, 2024, which is assigned to the assignee hereof, and which is expressly incorporated by reference in its entirety herein.

### TECHNICAL FIELD

The following relates to one or more systems for memory, including file update frequency indications for memory operations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports file update frequency indications for memory operations in accordance with examples as disclosed herein.

FIG. 2 shows an example of a process that supports file update frequency indications for memory operations in accordance with examples as disclosed herein.

FIG. 3 shows a block diagram of a host system that supports file update frequency indications for memory operations in accordance with examples as disclosed herein.

FIG. 4 shows a block diagram of a memory system that supports file update frequency indications for memory operations in accordance with examples as disclosed herein.

FIGS. 5 and 6 show flowcharts illustrating methods that support file update frequency indications for memory operations in accordance with examples as disclosed herein.

### DETAILED DESCRIPTION

A memory system may be used to store data associated with varying degrees of access frequency (e.g., update frequency, how frequently data is accessed, how frequently data is modified). For example, data associated with a relatively high access frequency (e.g., a relatively high quantity of access operations, relatively frequently-accessed data) may be referred to as hot data, and data associated with a relatively low access frequency (e.g., a relatively low quantity of access operations, relatively infrequently-accessed data) may be referred to as cold data. In some examples, a memory system may allocate one or more first blocks (e.g., hot region(s)) to facilitate the storage of hot data, and the first block(s) may be associated with a first type of access operation (e.g., reduced access latency, have lower voltages applied during access operations, have lower-stress operations), may have a first data retention characteristic (e.g., be configured for relatively short-term data retention), or may be associated with a first endurance characteristic, among other examples. Similarly, the memory system may allocate one or more second blocks (e.g., cold region(s)) to facilitate the storage of cold data, and the second block(s) may be associated with a second type of access operation to facilitate the storage of cold data (e.g., increased access latency, have higher voltages applied during access operations, increases stress operations), may have a second data retention characteristic (e.g., be configured for relatively long-term data retention), or may be associated with a second endurance characteristic, among other examples.

In some cases, a host system coupled with a memory system may implement a file system (e.g., a flash friendly file system (F2FS)) that separates data according to file types, including file types that may be assigned (e.g., fixed) as either hot data or cold data. However, such fixed assignments of data according to file types may lead to data of a given type being misassigned, resulting in various inefficiencies within the memory system. For example, data of a given file type may be assigned as cold data, and a memory system may continue to store the data in accordance with a cold data configuration (e.g., in a cold region) of the memory system even if the data is frequently accessed (e.g., is accessed in accordance with a hot data access frequency). Such a mismatch between a file type, as assigned with a fixed hot or cold designation, and the actual access frequency of a file, may result in increased latency at the host system and memory system, degraded user experience, among other disadvantages.

The techniques, methods, and devices described herein may be implemented to enable a host system to indicate an update frequency associated with a file (e.g., a frequency of updates to data of the file), such that a memory system may store data of the file to an appropriate region (e.g., a hot or cold region) or otherwise manage the data according to the indicated update frequency of the file. For example, a host system may determine an update to a file and transmit one or more commands to modify data of the file. The host system may also determine an update frequency of the file, which may be a function of a quantity of modified logical block addresses (LBAs) associated with the file, a duration since bootup (e.g., of the host system, of the memory system), a modification time of the update, or any combination thereof. If the update frequency of the file is greater than a threshold, indicating the file is updated frequently (e.g., accessed frequently), the host system may transmit a hot data indication associated with the file, such that the memory system may modify the data of the file and write the modified data of the file to the one or more first blocks (e.g., a hot region). Alternatively, if the update frequency of the data is less than or equal to a threshold, indicating that the data is updated less frequently (e.g., accessed less frequently), the host system may transmit a cold data indication associated with the file, such that the memory system may modify the data of the file and write the modified data of the file to the one or more second blocks (e.g., cold region). Accordingly, by receiving an update frequency indication associated with a file, a memory system may write data of the file to a region of memory suited for the update frequency of the file, and perform media management operations in accordance with the indicated update frequency of the file, thereby increasing efficiency during access operations, or improving memory allocation at runtime in the memory system, among other advantages.

In addition to applicability in memory systems as described herein, techniques for file update frequency indications for memory operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by writing data to hot and cold regions of memory based on a frequency at which the data is modified (e.g., updated), which may decrease access latency times while accessing the data, or improve efficiency during access operations, among other benefits.

Features of the disclosure are illustrated and described in the context of systems, devices, and circuits. Features of the disclosure are further illustrated and described in the context of flowcharts.

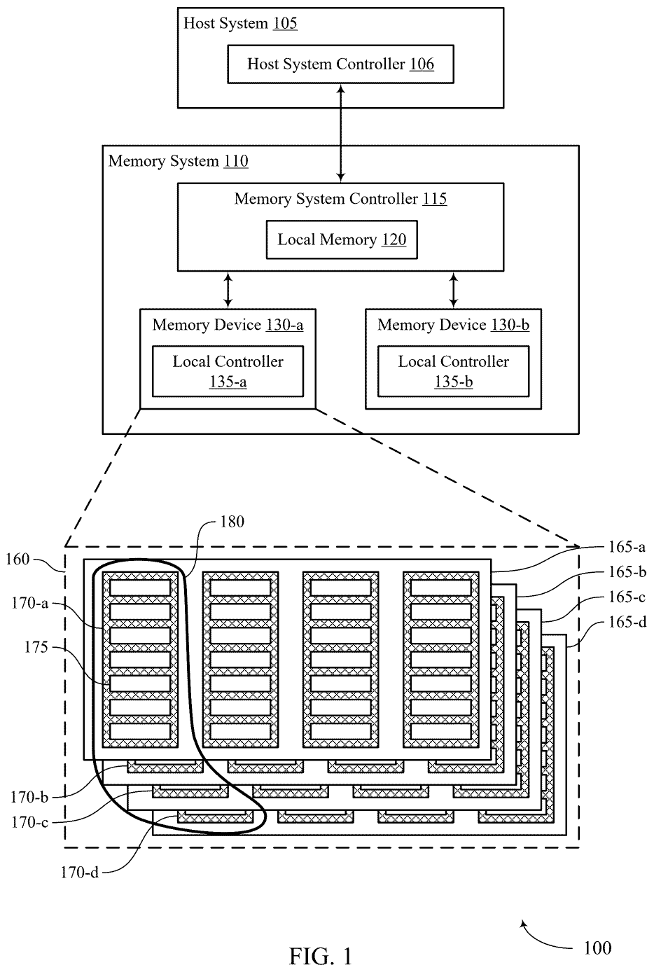

FIG. 1 shows an example of a system 100 that supports file update frequency indications for memory operations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

A memory system 110 may store data associated with varying degrees of access frequency (e.g., update frequency, how frequently data is accessed, how frequently data is updated). For example, data associated with a relatively high access frequency may be referred to as hot data, and data associated with a relatively low access frequency may be referred to as cold data. In some examples, a memory system 110 (e.g., a memory system controller 115, a local controller 135) may allocate one or more first blocks 170 (e.g., hot region(s)) to facilitate the storage of hot data, and the first block(s) 170 may be associated with a first type of access operation (e.g., reduced access latency, have lower voltages applied during access operations, have lower-stress operations), may have a first data retention characteristic (e.g., be configured for relatively short-term data retention), or may be associated with a first endurance characteristic, among other examples. Similarly, the memory system 110 may allocate one or more second blocks 170 (e.g., cold region(s)) to facilitate the storage of cold data, and the second block(s) 170 may be associated with a second type of access operation to facilitate the storage of cold data (e.g., increased access latency, may have higher voltages applied during access operations, increases stress operations), may have a second data retention characteristic (e.g., be configured for relatively long-term data retention), or may be associated with a second endurance characteristic, among other examples.

In some cases, a host system 105 may implement a file system (e.g., an F2FS) that separates data according to file types, including file types that may be assigned (e.g., fixed) as either hot data or cold data. However, such fixed assignments of data according to file types may lead to data of a given type being misassigned, resulting in various inefficiencies within a memory system 110. For example, data of a given file type may be assigned as cold data, and a memory system 110 may continue to store the data in accordance with a cold data configuration (e.g., in a cold region, of one or more memory devices 130) of the memory system 110 even if the data is frequently accessed (e.g., is accessed in accordance with a hot data access frequency). Such a mismatch between a file type, as assigned with a fixed hot or cold designation, and the actual access frequency of a file, may result in increased latency at the host system 105 and memory system 110, degraded user experience, among other disadvantages.

The techniques, methods, and devices described herein may be implemented to enable a host system 105 to indicate an update frequency associated with a file (e.g., a frequency of updates to data of the file), such that a memory system 110 may store data of the file to an appropriate region (e.g., a hot or cold region, of one or more memory devices 130) or otherwise manage the data according to the indicated update frequency of the file. For example, a host system 105 may determine an update to a file and transmit one or more commands (e.g., to a memory system 110) to modify data of the file. The host system 105 may also determine an update frequency of the file, which may be a function of a quantity of modified LBAs associated with the file, a duration since bootup (e.g., of the host system 105, of the memory system 110), a modification time of the update, or any combination thereof. If the update frequency of the file is greater than a threshold, indicating the file is updated frequently (e.g., accessed frequently), the host system 105 may transmit a hot data indication associated with the file, such that the memory system 110 may modify the data of the file and write the modified data of the file to the one or more first blocks 170 (e.g., a hot region). Alternatively, if the update frequency of the data is less than or equal to a threshold, indicating that the data is updated less frequently (e.g., accessed less frequently), the host system 105 may transmit a cold data indication associated with the file, such that the memory system 110 may modify the data of the file and write the modified data of the file to the one or more second blocks 170 (e.g., a cold region, of a same memory device 130 as a hot region, of a different memory device 130 than the hot region). Accordingly, by receiving an update frequency indication associated with a file, a memory system 110 may write data of the file to a region of memory suited for the update frequency of the file, and perform media management operations in accordance with the indicated update frequency of the file, thereby increasing efficiency during access operations, or improving memory allocation at runtime in the memory system 110, among other advantages.

The system 100 may include any quantity of non-transitory computer readable media that support file update frequency indications for memory operations. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

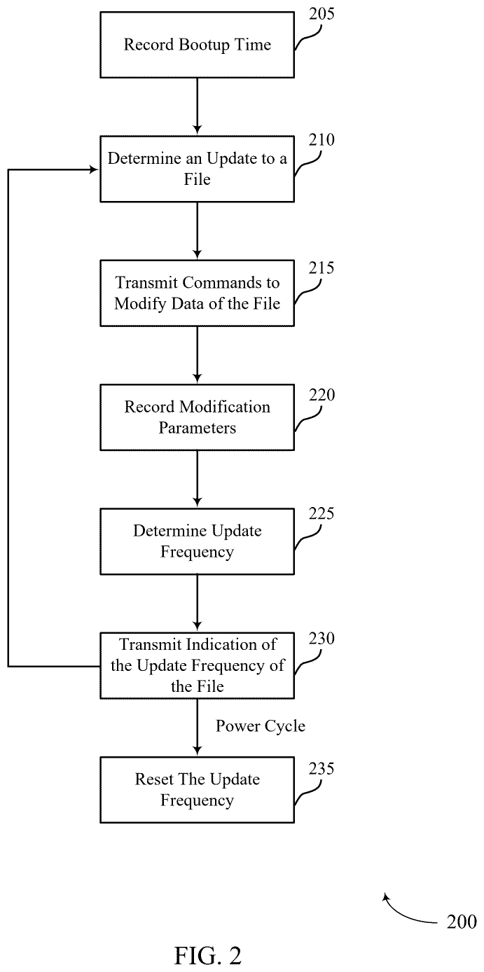

FIG. 2 shows an example of a process 200 that supports file update frequency indications for memory operations in accordance with examples as disclosed herein. Aspects of the process 200 may be implemented by a system 100 (e.g., by a host system 105, by a memory system 110). For example, aspects of the process 200 may be implemented using processing circuitry (e.g., one or more controllers), among other components. Additionally, or alternatively, aspects of the process 200 may be implemented using instructions stored in one or more memories (e.g., firmware stored in one or more memories coupled with the host system 105, the memory system 110, or both). For example, the instructions, when executed by processing circuitry (e.g., of a host system controller 106, of a memory system controller 115, or both), may cause the processing circuitry to perform, or cause a corresponding system to perform, the operations of the process 200. Additionally, some aspects of the process 200 may be performed by a host system 105 (e.g., at least in part by a host system controller 106), and some other aspects of the process 200 may be performed by a memory system 110 (e.g., at least in part by a memory system controller 115). The techniques described in the context of the process 200 may enable a host system 105 to indicate, based on a determined update frequency of a file, whether data of a file is hot or cold, such that a memory system 110 may write the data of the file to an appropriate region (e.g., blocks 170) of the memory system 110, or perform media management operations in accordance with an appropriate configuration (e.g., associated with hot or cold data), or both. Although aspects of the process 200 are described in the context of a single file, operations of the process 200 may be performed (e.g., concurrently) for any quantity of one or more files.

In some examples, a host system 105 may implement a file system (e.g., F2FS) that identifies a temperature of data, and the data may be stored in one or more blocks 170 of a memory system 110 according to the temperature of the data. As described herein, temperature of the data may be used to refer to an access frequency (e.g., an update frequency, quantized as a quantity of access operations, how frequently data is modified) of data, and a memory system 110 may allocate different blocks 170 to accommodate data with different temperatures. For example, a memory system 110 may allocate one or more first blocks 170 (e.g., a hot region) to facilitate the storage of hot data (e.g., data with relatively high access frequency, data with relatively high update frequency), and the first block(s) 170 may be associated with a first type of access operation (e.g., reduced access latency, have lower voltages applied during access operations, have lower-stress operations), have a first data retention characteristic (e.g., be configured for relatively short-term data retention, be configured with SLCs, be volatile memory, RAM, or cache), or be associated with a first endurance characteristic, among other examples. Similarly, the memory system 110 may allocate one or more second blocks 170 (e.g., a cold region) to facilitate the storage of cold data (e.g., data with relatively low access frequency, data with relatively low update frequency), where the second block(s) 170 may be associated with a second type of access operation to facilitate the storage of cold data (e.g., increased access latency, have higher voltages applied during access operations, increases stress operations), have a second data retention characteristic (e.g., be configured for relatively long-term data retention, be configured with multiple level cells such as MLCs, TLCs, or QLCs, be non-volatile memory), or be associated with a second endurance characteristic, among other examples.

In some cases, a host system 105 (e.g., via the file system) may separate hot and cold data according to associated file types. As an illustrative example (e.g., in accordance with a Linux kernel), inodes of directory files (e.g., metadata associated with a file of the file system) may be assigned (e.g., regarded) as hot data, while multi-media or compressed files may be assigned (e.g., regarded) as cold data. In such cases, the host system 105 may assign (e.g., fix) each file within the file system as either hot data or cold data according to the file types in response to a system image being generated (e.g., burned) at the host system 105.

In some examples, fixing the temperature of each file within the file system may lead to various inefficiencies within a memory system 110, for example, due to a temperature of a file within the file system dynamically changing over time. As an illustrative example, a host system 105 may assign a file as being hot data. If, during runtime, the file is accessed or updated infrequently (e.g., is cold data), the host system 105 may still regard the file as hot data, such that a memory system 110 may continue to store or manage the file in a hot region, which may limit an available size of the hot region. Accordingly, fixing the temperature of each file type may lead to an inability to track temperature of files at runtime, such that a memory system 110 may allocate blocks 170 for hot data or cold data based on inaccurate temperatures of the files.

The techniques described herein may enable a host system 105 (e.g., a host system controller 106) to dynamically indicate the temperature of files to a memory system 110, such that the memory system 110 (e.g., a memory system controller 115) may allocate and store data in regions of memory according to the temperature of the files during runtime.

At 205, a bootup time may be recorded. For example, the host system 105 (e.g., a host system controller 106) may record a timestamp associated with a powering on (e.g., bootup) of the host system 105, one or more coupled memory systems 110, or a combination thereof. The host system 105 may store the bootup time in memory (e.g., volatile memory) associated with the host system controller 106, in local memory 120, in a memory device 130, or multiple of such locations. The host system 105 (e.g., via a Linux kernel operated by the host system controller 106) may also maintain a duration since the bootup time of the host system 105 and the memory system(s) 110.

At 210, an update to a file may be determined. For example, the host system 105 (e.g., the host system controller 106) may determine to update the file of the file system, which may include modifying existing data of the file, appending additional data to the file, invalidating a portion of the file (e.g., for deleting a portion the file), or any combination thereof. In such examples, the file may be associated with a set of LBAs, and one or more memory devices 130 of the memory system 110 may store the file in one or more blocks 170 associated with the set of LBAs.

At 215, commands to modify data of the file may be transmitted. For example, the host system 105 (e.g., the host system controller 106) may transmit one or more commands (e.g., to the memory system 110) to modify data of the file (e.g., as stored in at least one LBA of the set of LBAs). In some examples, to modify data of the file, the host system 105 may transmit a read command directed to the at least one of the LBAs to obtain the data from the memory system 110 (e.g., from one or more memory devices 130). In response to obtaining the data, the host system 105 (e.g., the host system controller 106) may modify the data of the file (e.g., modify existing data, add additional data, delete existing data). In response to modifying the data of the file, the host system 105 (e.g., the host system controller 106) may transmit a write command, and the memory system 110 (e.g., the memory system controller 115) may write the modified data to one or more of the memory devices 130.

At 220, modification parameters may be recorded. For example, the host system 105 (e.g., the host system controller 106) may record one or more modification parameters associated with modifying the data of the file. The host system 105 may store the modification parameter(s) in metadata (e.g., an inode) of the file, and the modification parameter(s) may include a modification time (e.g., a timestamp of the operations of 215), a total quantity of modified LBAs associated with the file, or both. In some examples, the host system 105 may determine the total quantity of modified LBAs associated with the file according to a first quantity of LBAs modified in the operations of 215 and a second quantity of LBAs associated with one or more previous updates of the file. That is, a total quantity of modified LBAs may be equal to a combination of a quantity of modified LBAs during a current update and a previous total quantity of modified LBAs.

As an illustrative example, at bootup, a memory system 110 may store a file across 10 LBAs of one or more memory devices 130. As part of a first update of the file (e.g., in accordance with an update determined at 210), the host system 105 (e.g., the host system controller 106) may modify data stored in 8 of the 10 LBAs and may also append 5 LBAs of data to the file. In response, the host system 105 may record (e.g., as part of metadata associated with the file) that the total quantity of modified LBAs is 8 and also record the modification time of the first update. In some other examples, the host system 105 may record that the total quantity of modified LBAs is 13, to include the 8 modified LBAs and the 5 appended LBAs. The memory system controller 115 may, in response to receiving one or more commands (e.g., of 215), modify the data stored at the 8 LBAs and store the appended data in 5 additional LBAs, such that the file is stored across 15 LBAs. As part of a second update to the file, the host system 105 may modify data of the file that is stored in 11 of the 15 LBAs and indicate the modifications to the memory system controller 115, such that the memory system controller 115 may modify the data stored in the 11 of the 15 LBAs. As such, the host system controller 106 may record, as part of metadata associated with the file, that the total quantity of modified LBAs is 19 (e.g., for the example of 8 modified LBAs from the previous total quantity of modified LBAs and 11 modified LBAs from the second update) and also record the modification time of the second update.

At 225, an update frequency associated with the file may be determined. For example, in response to recording the modification parameters, the host system 105 (e.g., the host system controller 106) may determine the update frequency of the file as a function of the modification time of the current update, the total quantity of modified LBAs, the duration since bootup (e.g., of the host system 105), or any combination thereof. For example, the host system 105 may calculate the update frequency according to Equation 1, as follows:

$$Update Frequency = ( \frac{Total Quantity of Modified LBAs}{Duration Since Bootup} ) * Modification Time \qquad ( 1 )$$

In such examples, as the total quantity of modified LBAs increases or as the modification time increases, the update frequency of the file may also increase. Alternatively, as a duration since bootup increases and the total quantity of modified LBAs remains constant, the update frequency of the file may decrease.

At 230, an indication of the update frequency of the file may be transmitted. For example, in response to determining the update frequency at 225, the host system 105 (e.g., the host system controller 106) may transmit an indication of the update frequency to the memory system 110, such that the memory system 110 (e.g., the memory system controller 115) may access the one or more memory devices 130 and modify the data associated with the file, or perform media management operations associated with data of the file, or both in accordance with the indicated update frequency.

In some examples, the host system 105 (e.g., the host system controller 106) may determine whether the determined update frequency of 225 satisfies a threshold, and the transmitted indication of the update frequency may be based on whether the update frequency satisfies the threshold. For example, if the update frequency is greater than the threshold (e.g., if the file is relatively frequently updated), the host system 105 may classify the file as hot data and transmit a hot data indication to the memory system 110 (e.g., to the memory system controller 115), such that the memory system 110 may write modified data of the file or perform media management operations in accordance with a hot region of memory. For example, in response to receiving a hot data indication, the memory system 110 may access one or more memory devices 130 to modify the data of the file or perform the media management operations. If the data of the file was previously stored in a hot region of memory, the memory system 110 may maintain the data of the file in the hot region of memory, where, in some examples, the memory system 110 may allocate additional portions of the hot region of memory to accommodate data added to the file. If the data of the file was previously stored in a cold region of memory, the memory system 110 may allocate portions of the hot region of memory and move the data of the file from the cold region of memory to the allocated portions of the hot region of memory. In some other examples, the memory system 110 may perform media management operations, such as garbage collection, refresh, or wear leveling, in accordance with the indication that the file is associated with hot data (e.g., determining if, when, or how to perform one or more media management operations as a function of the data of the file being updated relatively frequently).

Alternatively, if the update frequency is less than or equal to the threshold (e.g., if the file is relatively infrequently updated), the host system 105 may classify the file as cold data and transmit a cold data indication to the memory system 110, such that the memory system 110 may write modified data of the file or perform media management operations in accordance with a cold region of memory. In such examples, the host system 105 may include the update frequency indication (e.g., hot or cold data indication) with a group number indication of a write command associated with writing the data of the file. For example, in response to receiving the cold data indication, the memory system 110 may access one or more memory devices 130 to modify the data of the file or perform the media management operations. If the data of the file was previously stored in a cold region of memory, the memory system 110 may maintain the data of the file in the cold region of memory, where, in some examples, the memory system 110 may allocate additional portions of the cold region of memory to accommodate data added to the file. If the data of the file was previously stored in a hot region of memory, the memory system 110 may allocate portions of the cold region of memory and move the data of the file from the hot region of memory to the allocated portions of the cold region of memory. In some other examples, the memory system 110 may perform media management operations, such as garbage collection, refresh, or wear leveling, in accordance with the indication that the file is associated with cold data (e.g., determining if, when, or how to perform one or more media management operations as a function of the data of the file being updated relatively infrequently).

In response to transmitting the indication of the update frequency, the host system 105 (e.g., the host system controller 106) may continue to determine additional updates to the file or determine updates to additional files at 210. It should be understood that the operations at 215, 220, 225, and 230 may be performed simultaneously or in any order. For example, in response to determining an update to a file at 210, the host system 105 may modify the data of the file, record the modification parameters and determine the update frequency, transmit the indication of the update frequency of the file, and transmit the one or more commands to modify the data of the file.

At 235, the update frequency may be reset. For example, in response to a power cycle (e.g., of the host system 105), the host system 105 (e.g., the host system controller 106) may reset the update frequency of each file within the file system.

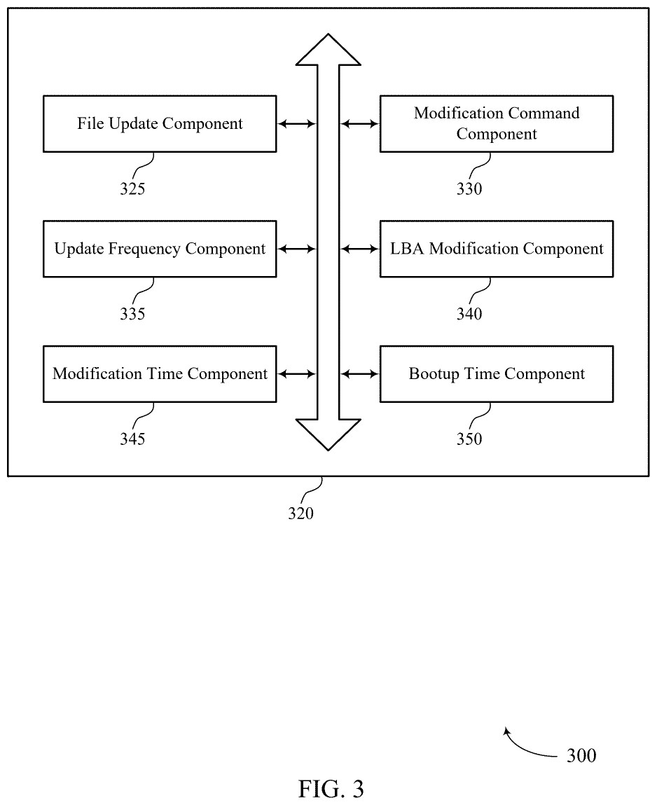

FIG. 3 shows a block diagram 300 of a host system 320 that supports file update frequency indications for memory operations in accordance with examples as disclosed herein. The host system 320 may be an example of aspects of a host system as described with reference to FIGS. 1 through 2. The host system 320, or various components thereof, may be an example of means for performing various aspects of file update frequency indications for memory operations as described herein. For example, the host system 320 may include a file update component 325, a modification command component 330, an update frequency component 335, an LBA modification component 340, a modification time component 345, a bootup time component 350, or any combination thereof. Each of these components, or components of subcomponents thereof (e.g., one or more processors, one or more memories), may communicate, directly or indirectly, with one another (e.g., via one or more buses).

The file update component 325 may be configured as or otherwise support a means for determining, at the host system, an update to a file associated with a set of one or more LBAs of a memory system in accordance with a file system of the host system. The modification command component 330 may be configured as or otherwise support a means for transmitting, from the host system, one or more commands to modify data of at least one of the set of one or more LBAs of the memory system associated with the file in accordance with the determined update. The update frequency component 335 may be configured as or otherwise support a means for transmitting, from the host system, an indication of an update frequency associated with the file that is determined as a function of the determined update.

In some examples, the update frequency component 335 may be configured as or otherwise support a means for determining, in response to determining the update to the file, whether the update frequency associated with the file satisfies a threshold, where the transmitted indication of the update frequency associated with the file indicates whether the update frequency associated with the file satisfies the threshold.

In some examples, the transmitted indication may include a hot data indication associated with the file in response to the update frequency associated with the file being greater than the threshold. Additionally, or alternatively, the transmitted indication may include a cold data indication associated with the file in response to the update frequency associated with the file being less than the threshold.

In some examples, the update frequency component 335 may be configured as or otherwise support a means for determining the update frequency associated with the file as a function of a total quantity of modified LBAs associated with the file, a duration since a bootup of the host system, a modification time associated with the update to the file, or a combination thereof.

In some examples, the LBA modification component 340 may be configured as or otherwise support a means for recording a first quantity of modified LBAs associated with the determined update to the file, where the total quantity of modified LBAs associated with the file is a function of the recorded first quantity of modified LBAs, a recorded second quantity of modified LBAs associated with a second update to the file before the update to the file, or a combination thereof.

In some examples, the modification time component 345 may be configured as or otherwise support a means for recording, at the host system, the modification time associated with the update to the file in metadata associated with the file, where the update frequency associated with the file is determined as a function of the recorded modification time in the metadata associated with the file.

In some examples, the bootup time component 350 may be configured as or otherwise support a means for recording, at the host system, the duration since bootup of the host system, where the update frequency associated with the file is determined as a function of the recorded duration since bootup.

In some examples, the update frequency component 335 may be configured as or otherwise support a means for resetting the update frequency associated with the file in response to a power cycle of the host system, a reset of the host system, or a combination thereof.

In some examples, the described functionality of the host system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 320, or various components thereof, may be implemented at least in part by instructions (e.g., stored in memory, non-transitory computer-readable medium) executable by such at least one processor.

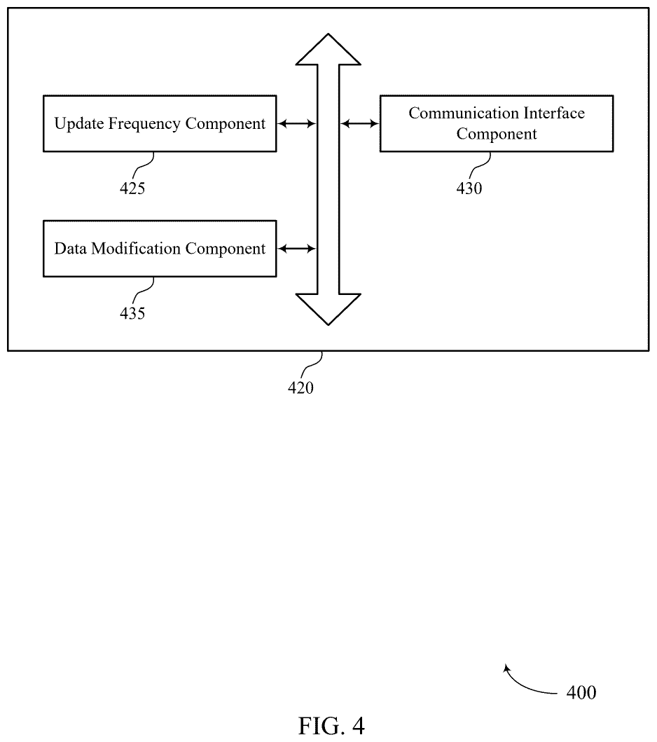

FIG. 4 shows a block diagram 400 of a memory system 420 that supports file update frequency indications for memory operations in accordance with examples as disclosed herein. The memory system 420 may be an example of aspects of a memory system as described with reference to FIGS. 1 through 2. The memory system 420, or various components thereof, may be an example of means for performing various aspects of file update frequency indications for memory operations as described herein. For example, the memory system 420 may include an update frequency component 425, a communication interface component 430, a data modification component 435, or any combination thereof. Each of these components, or components of subcomponents thereof (e.g., one or more processors, one or more memories), may communicate, directly or indirectly, with one another (e.g., via one or more buses).

The update frequency component 425 may be configured as or otherwise support a means for receiving, at the memory system, an indication of an update frequency associated with a file, the file associated with a set of one or more LBAs of the memory system in accordance with a file system. The communication interface component 430 may be configured as or otherwise support a means for receiving, at the memory system, one or more commands to modify data of at least one of the set of one or more LBAs associated with the file. The data modification component 435 may be configured as or otherwise support a means for accessing one or more memory devices of the memory system to modify the data of the at least one of the set of one or more LBAs associated with the file in accordance with the received one or more commands and the received indication of the update frequency associated with the file.

In some examples, to support accessing the one or more memory devices, the data modification component 435 may be configured as or otherwise support a means for writing the modified data associated with the file to one or more first blocks of memory in response to the received indication indicating that the update frequency associated with the file is greater than a threshold. In some examples, to support accessing the one or more memory devices, the data modification component 435 may be configured as or otherwise support a means for writing the modified data associated with the file to one or more second blocks of memory in response to the received indication indicating that the update frequency associated with the file is less than the threshold.

In some examples, the one or more first blocks of memory are associated with a first access latency; and the one or more second blocks of memory are associated with a second access latency that is greater than the first access latency.

In some examples, the one or more first blocks of memory are associated with a first endurance characteristic; and the one or more second blocks of memory are associated with a second endurance characteristic that is different than the first endurance characteristic.

In some examples, the one or more first blocks of memory are associated with a first data retention duration; and the one or more second blocks of memory are associated with a second data retention duration that is different than the first data retention duration.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

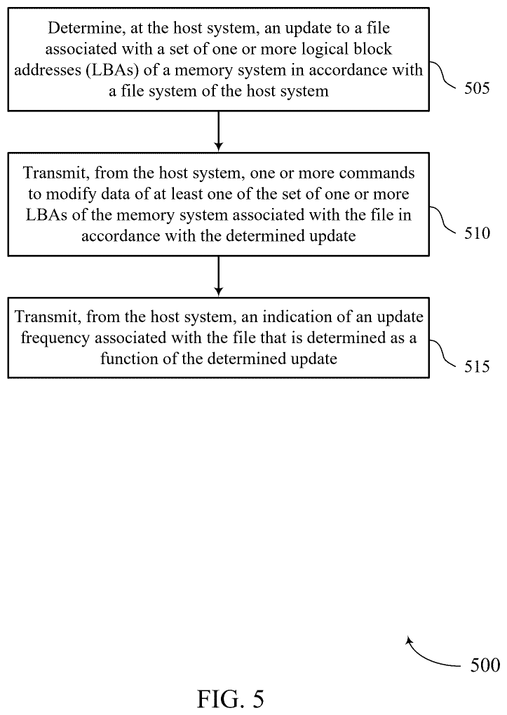

FIG. 5 shows a flowchart illustrating a process 500 that supports file update frequency indications for memory operations in accordance with examples as disclosed herein. The operations of process 500 may be implemented by a host system or its components as described herein. For example, the operations of process 500 may be performed by a host system as described with reference to FIGS. 1 through 3. In some examples, a host system may execute a set of instructions to control the functional elements of the device to perform the described functions. Additionally, or alternatively, the host system may perform aspects of the described functions using special-purpose hardware.

At 505, the process may include determining, at the host system, an update to a file associated with a set of one or more LBAs of a memory system in accordance with a file system of the host system. In some examples, aspects of the operations of 505 may be performed by a file update component 325 as described with reference to FIG. 3.

At 510, the process may include transmitting, from the host system, one or more commands to modify data of at least one of the set of one or more LBAs of the memory system associated with the file in accordance with the determined update. In some examples, aspects of the operations of 510 may be performed by a modification command component 330 as described with reference to FIG. 3.

At 515, the process may include transmitting, from the host system, an indication of an update frequency associated with the file that is determined as a function of the determined update. In some examples, aspects of the operations of 515 may be performed by an update frequency component 335 as described with reference to FIG. 3.

In some examples, an apparatus as described herein may perform a process or processes, such as the process 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining, at the host system, an update to a file associated with a set of one or more LBAs of a memory system in accordance with a file system of the host system; transmitting, from the host system, one or more commands to modify data of at least one of the set of one or more LBAs of the memory system associated with the file in accordance with the determined update; and transmitting, from the host system, an indication of an update frequency associated with the file that is determined as a function of the determined update.

Aspect 2: The method, apparatus, or non-transitory computer-readable medium of aspect 1, further including operations, features, circuitry, logic, means, or instructions, or any combination thereof for determining, in response to determining the update to the file, whether the update frequency associated with the file satisfies a threshold, where the transmitted indication of the update frequency associated with the file indicates whether the update frequency associated with the file satisfies the threshold.

Aspect 3: The method, apparatus, or non-transitory computer-readable medium of aspect 2, where the transmitted indication includes a hot data indication associated with the file in response to the update frequency associated with the file being greater than the threshold; and the transmitted indication includes a cold data indication associated with the file in response to the update frequency associated with the file being less than the threshold.

Aspect 4: The method, apparatus, or non-transitory computer-readable medium of any of aspects 1 through 3, further including operations, features, circuitry, logic, means, or instructions, or any combination thereof for determining the update frequency associated with the file as a function of a total quantity of modified LBAs associated with the file, a duration since a bootup of the host system, a modification time associated with the update to the file, or a combination thereof.

Aspect 5: The method, apparatus, or non-transitory computer-readable medium of aspect 4, further including operations, features, circuitry, logic, means, or instructions, or any combination thereof for recording a first quantity of modified LBAs associated with the determined update to the file, where the total quantity of modified LBAs associated with the file is a function of the recorded first quantity of modified LBAs, a recorded second quantity of modified LBAs associated with a second update to the file before the update to the file, or a combination thereof.

Aspect 6: The method, apparatus, or non-transitory computer-readable medium of any of aspects 4 through 5, further including operations, features, circuitry, logic, means, or instructions, or any combination thereof for recording, at the host system, the modification time associated with the update to the file in metadata associated with the file, where the update frequency associated with the file is determined as a function of the recorded modification time in the metadata associated with the file.

Aspect 7: The method, apparatus, or non-transitory computer-readable medium of any of aspects 4 through 6, further including operations, features, circuitry, logic, means, or instructions, or any combination thereof for recording, at the host system, the duration since bootup of the host system, where the update frequency associated with the file is determined as a function of the recorded duration since bootup.

Aspect 8: The method, apparatus, or non-transitory computer-readable medium of any of aspects 1 through 7, further including operations, features, circuitry, logic, means, or instructions, or any combination thereof for resetting the update frequency associated with the file in response to a power cycle of the host system, a reset of the host system, or a combination thereof.

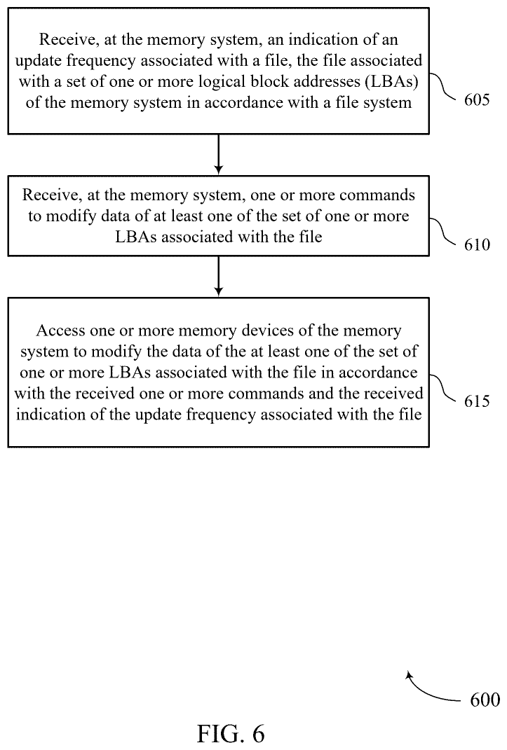

FIG. 6 shows a flowchart illustrating a process 600 that supports file update frequency indications for memory operations in accordance with examples as disclosed herein. The operations of process 600 may be implemented by a memory system or its components as described herein. For example, the operations of process 600 may be performed by a memory system as described with reference to FIGS. 1 through 2 and 4. In some examples, a memory system may execute a set of instructions to control the functional elements of the device to perform the described functions. Additionally, or alternatively, the memory system may perform aspects of the described functions using special-purpose hardware.

At 605, the process may include receiving, at the memory system, an indication of an update frequency associated with a file, the file associated with a set of one or more LBAs of the memory system in accordance with a file system. In some examples, aspects of the operations of 605 may be performed by an update frequency component 425 as described with reference to FIG. 4.

At 610, the process may include receiving, at the memory system, one or more commands to modify data of at least one of the set of one or more LBAs associated with the file. In some examples, aspects of the operations of 610 may be performed by a communication interface component 430 as described with reference to FIG. 4.

At 615, the process may include accessing one or more memory devices of the memory system to modify the data of the at least one of the set of one or more LBAs associated with the file in accordance with the received one or more commands and the received indication of the update frequency associated with the file. In some examples, aspects of the operations of 615 may be performed by a data modification component 435 as described with reference to FIG. 4.

In some examples, an apparatus as described herein may perform a process or processes, such as the process 600. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for receiving, at the memory system, an indication of an update frequency associated with a file, the file associated with a set of one or more LBAs of the memory system in accordance with a file system; receiving, at the memory system, one or more commands to modify data of at least one of the set of one or more LBAs associated with the file; and accessing one or more memory devices of the memory system to modify the data of the at least one of the set of one or more LBAs associated with the file in accordance with the received one or more commands and the received indication of the update frequency associated with the file.

Aspect 10: The method, apparatus, or non-transitory computer-readable medium of aspect 9, where accessing the one or more memory devices includes operations, features, circuitry, logic, means, or instructions, or any combination thereof for writing the modified data associated with the file to one or more first blocks of memory in response to the received indication indicating that the update frequency associated with the file is greater than a threshold and writing the modified data associated with the file to one or more second blocks of memory in response to the received indication indicating that the update frequency associated with the file is less than the threshold.

Aspect 11: The method, apparatus, or non-transitory computer-readable medium of aspect 10, where the one or more first blocks of memory are associated with a first access latency; and the one or more second blocks of memory are associated with a second access latency that is greater than the first access latency.

Aspect 12: The method, apparatus, or non-transitory computer-readable medium of any of aspects 10 through 11, where the one or more first blocks of memory are associated with a first endurance characteristic; and the one or more second blocks of memory are associated with a second endurance characteristic that is different than the first endurance characteristic.

Aspect 13: The method, apparatus, or non-transitory computer-readable medium of any of aspects 10 through 12, where the one or more first blocks of memory are associated with a first data retention duration; and the one or more second blocks of memory are associated with a second data retention duration that is different than the first data retention duration.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A host system, comprising:
one or more interfaces comprising one or more signal paths operable for communication with one or more memory systems; and
processing circuitry coupled with the one or more interfaces and configured to cause the host system to:
determine, at the host system, an update to a file associated with a set of one or more logical block addresses (LBAs) of a memory system in accordance with a file system of the host system;
transmit, from the host system, one or more commands to modify data of at least one of the set of one or more LBAs of the memory system associated with the file in accordance with the determined update; and
transmit, from the host system, an indication of an update frequency associated with the file that is determined as a function of the determined update.

2. The host system of claim 1, wherein the processing circuitry is further configured to cause the host system to:
determine, in response to determining the update to the file, whether the update frequency associated with the file satisfies a threshold, wherein the transmitted indication of the update frequency associated with the file indicates whether the update frequency associated with the file satisfies the threshold.

3. The host system of claim 2, wherein:
the transmitted indication comprises a hot data indication associated with the file in response to the update frequency associated with the file being greater than the threshold; and
the transmitted indication comprises a cold data indication associated with the file in response to the update frequency associated with the file being less than the threshold.

4. The host system of claim 1, wherein the processing circuitry is further configured to cause the host system to:
determine the update frequency associated with the file as a function of a total quantity of modified LBAs associated with the file, a duration since a bootup of the host system, a modification time associated with the update to the file, or a combination thereof.

5. The host system of claim 4, wherein the processing circuitry is further configured to cause the host system to:
record a first quantity of modified LBAs associated with the determined update to the file, wherein the total quantity of modified LBAs associated with the file is a function of the recorded first quantity of modified LBAs, a recorded second quantity of modified LBAs associated with a second update to the file before the update to the file, or a combination thereof.

6. The host system of claim 4, wherein the processing circuitry is further configured to cause the host system to:
recording, at the host system, the modification time associated with the update to the file in metadata associated with the file, wherein the update frequency associated with the file is determined as a function of the recorded modification time in the metadata associated with the file.

7. The host system of claim 4, wherein the processing circuitry is further configured to cause the host system to:
recording, at the host system, the duration since bootup of the host system, wherein the update frequency associated with the file is determined as a function of the recorded duration since bootup.

8. The host system of claim 1, wherein the processing circuitry is further configured to cause the host system to:
reset the update frequency associated with the file in response to a power cycle of the host system, a reset of the host system, or a combination thereof.

9. A memory system, comprising:
one or more memory devices; and
processing circuitry coupled with the one or more memory devices and configured to cause the memory system to:
receive, at the memory system, an indication of an update frequency associated with a file, the file associated with a set of one or more logical block addresses (LBAs) of the memory system in accordance with a file system;
receive, at the memory system, one or more commands to modify data of at least one of the set of one or more LBAs associated with the file; and
access the one or more memory devices to modify the data of the at least one of the set of one or more LBAs associated with the file in accordance with the received one or more commands and the received indication of the update frequency associated with the file.

10. The memory system of claim 9, wherein, to access the one or more memory devices, the processing circuitry is configured to cause the memory system to:
write the modified data associated with the file to one or more first blocks of memory in response to the received indication indicating that the update frequency associated with the file is greater than a threshold; or
write the modified data associated with the file to one or more second blocks of memory in response to the received indication indicating that the update frequency associated with the file is less than the threshold.

11. The memory system of claim 10, wherein the one or more first blocks of memory are associated with a first access latency; and the one or more second blocks of memory are associated with a second access latency that is greater than the first access latency.

12. The memory system of claim 10, wherein the one or more first blocks of memory are associated with a first endurance characteristic; and the one or more second blocks of memory are associated with a second endurance characteristic that is different than the first endurance characteristic.

13. The memory system of claim 10, wherein the one or more first blocks of memory are associated with a first data retention duration; and the one or more second blocks of memory are associated with a second data retention duration that is different than the first data retention duration.

14. A non-transitory computer-readable medium storing code comprising instructions which, when executed by processing circuitry of a host system, cause the host system to:
determine, at the host system, an update to a file associated with a set of one or more logical block addresses (LBAs) of a memory system in accordance with a file system of the host system;
transmit, from the host system, one or more commands to modify data of at least one of the set of one or more LBAs of the memory system associated with the file in accordance with the determined update; and
transmit, from the host system, an indication of an update frequency associated with the file that is determined as a function of the determined update.

15. The non-transitory computer-readable medium of claim 14, wherein the instructions, when executed by the processing circuitry of the host system, further cause the host system to:
determine, in response to determining the update to the file, whether the update frequency associated with the file satisfies a threshold, wherein the transmitted indication of the update frequency associated with the file indicates whether the update frequency associated with the file satisfies the threshold.

16. The non-transitory computer-readable medium of claim 15, wherein the transmitted indication comprises a hot data indication associated with the file in response to the update frequency associated with the file being greater than the threshold; and the transmitted indication comprises a cold data indication associated with the file in response to the update frequency associated with the file being less than the threshold.

17. The non-transitory computer-readable medium of claim 14, wherein the instructions, when executed by the processing circuitry of the host system, further cause the host system to:
determine the update frequency associated with the file as a function of a total quantity of modified LBAs associated with the file, a duration since a bootup of the host system, a modification time associated with the update to the file, or a combination thereof.

18. The non-transitory computer-readable medium of claim 17, wherein the instructions, when executed by the processing circuitry of the host system, further cause the host system to:
record a first quantity of modified LBAs associated with the determined update to the file, wherein the total quantity of modified LBAs associated with the file is a function of the recorded first quantity of modified LBAs, a recorded second quantity of modified LBAs associated with a second update to the file before the update to the file, or a combination thereof.

19. The non-transitory computer-readable medium of claim 17, wherein the instructions, when executed by the processing circuitry of the host system, further cause the host system to:
record, at the host system, the modification time associated with the update to the file in metadata associated with the file, wherein the update frequency associated with the file is determined as a function of the recorded modification time in the metadata associated with the file.

20. The non-transitory computer-readable medium of claim 17, wherein the instructions, when executed by the processing circuitry of the host system, further cause the host system to:
record, at the host system, the duration since bootup of the host system, wherein the update frequency associated with the file is determined as a function of the recorded duration since bootup.

21. The non-transitory computer-readable medium of claim 14, wherein the instructions, when executed by the processing circuitry of the host system, further cause the host system to:
reset the update frequency associated with the file in response to a power cycle of the host system, a reset of the host system, or a combination thereof.

22. A non-transitory computer-readable medium storing code comprising instructions which, when executed by processing circuitry of a memory system, cause the memory system to:
receive, at the memory system, an indication of an update frequency associated with a file, the file associated with a set of one or more logical block addresses (LBAs) of the memory system in accordance with a file system;
receive, at the memory system, one or more commands to modify data of at least one of the set of one or more LBAs associated with the file; and
access one or more memory devices of the memory system to modify the data of the at least one of the set of one or more LBAs associated with the file in accordance with the received one or more commands and the received indication of the update frequency associated with the file.

23. The non-transitory computer-readable medium of claim 22, wherein the instructions to access the one or more memory devices, when executed by the processing circuitry of the memory system, cause the memory system to:
write the modified data associated with the file to one or more first blocks of memory in response to the received indication indicating that the update frequency associated with the file is greater than a threshold; or
write the modified data associated with the file to one or more second blocks of memory in response to the received indication indicating that the update frequency associated with the file is less than the threshold.
